(19) United States
(12) Patent Application Publication
(10) Pub. No.: US 2014/0072240 A1
(43) Pub. Date: Mar. 13, 2014

(54) METHOD AND APPARATUS FOR CONVERTING AN IMAGE, AND METHOD AND APPARATUS FOR INVERSE CONVERTING AN IMAGE

(71) Applicants: Tammy Lee, Seoul (KR); Il-koo Kim, Osan-si (KR); Woo-jin Han, Suwon-si (KR); Jianle Chen, Suwon-si (KR)

(72) Inventors: Tammy Lee, Seoul (KR); Il-koo Kim, Osan-si (KR); Woo-jin Han, Suwon-si (KR); Jianle Chen, Suwon-si (KR)

(73) Assignee: SAMSUNG ELECTRONICS CO., LTD., Suwon-si (KR)

(21) Appl. No.: 14/001,618

(22) PCT Filed: Feb. 24, 2012
(86) PCT No.: PCT/KR2012/001446

§ 371 Date: Nov. 4, 2013

Related U.S. Application Data
(60) Provisional application No. 61/446,753, filed on Feb. 25, 2011.

(51) Int. Cl. G06T 9/00

(52) U.S. Cl. CPC G06T 9/007
USPC 382/250

(57) ABSTRACT

An image transformation method substitutes element based on a trigonometric function included in a discrete cosine transform (DCT) matrix with a rational number, performs upscaling and transformation process on an input signal using the substituted DCT matrix based on a maximum value of a denominator of an intermediate value generated in the transformation process, and performs downscaling on the transformed signal.

### CROSS-REFERENCE TO RELATED APPLICATION(S)

This application is a national stage entry under 35 U.S.C. 371(c) of International Patent Application No. PCT/KR2012/001446, filed Feb. 25, 2011, and claims priority from U.S. Provisional Application No. 61/446,753, filed on 25 Feb. 2011, the disclosures of which are incorporated herein by reference in their entireties.

### BACKGROUND

1. Field

Apparatuses and methods consistent with exemplary embodiments relate to a method and an apparatus for encoding and decoding an image, and more particularly, to a method and an apparatus for transforming and inverse-transforming an image block having a larger size.

2. Description of the Related Art

In video coding methods such as H.264 and MPEG-4, a video signal is hierarchically divided into sequences, frames, slices, macro blocks, and blocks, and a block is a minimum processing unit. At an encoding side, predicted residual information of a block is obtained through an intra-frame or an inter-frame, block transformation is performed so that energy may be concentrated on a fewer number of coefficients, and image data is compressed through quantization, scanning, run-length coding, and entropy coding. At a decoding side, a block transformation coefficient of entropy coding is extracted from a bit stream. The predicted residual information of a block is reconfigured through inverse-quantization and inverse-transformation. Predicted information is used to reconfigure video data of a block. In an encoding-decoding process, a transformation module is a basis in video compression and transformation capability thereof directly affects general performance of a codec.

Discrete cosine transformation (DCT) is adopted in an earlier video coding standard such as H.264 and MPEG-4. After the proposal of DCT in 1974, DCT has been widely used in the field of image and video coding. DCT removes correlation of an image component in a transformation domain and provides a basis for higher efficient image compression. However, since a DCT transformation matrix is presented by a floating point number, a larger amount of system resources may be consumed due to a larger amount of floating point calculation. To improve transformation efficiency and perform transformation of a block having a larger size, a new DCT transformation algorithm is increasingly needed.

### SUMMARY

One or more exemplary embodiments provide a method and apparatus for transforming and/or inverse-transforming an image in which a transformation error occurring in a discrete cosine transformation (DCT) process may be reduced and a calculation speed of the DCT process may be improved.

One or more exemplary embodiments also provide a method and apparatus for transforming and/or inverse-transforming an image in which a transformation error may be reduced through a scaling process of a signal input to a transformation unit and a signal output from the transformation unit and a calculation speed of a discrete cosine transformation (DCT) process may be improved.

According to an aspect of an exemplary embodiment, there is provided a method of transforming an image, the method including: obtaining a substituted discrete cosine transformation (DCT) matrix by substituting values based on a trigonometric function among elements of an N×N transformation matrix used for one-dimensional DCT of an N×N block with predetermined rational numbers, wherein the N is an integer; obtaining an upscaling matrix for upscaling elements of the N×N block based on a maximum value of a denominator of an intermediate value generated in a calculation process of transforming the N×N block by using the substituted DCT matrix; transforming the N×N block by using the upscaling matrix and the substituted DCT matrix; and downscaling a transformed N×N block based on the maximum value of the denominator of the intermediate value generated in the calculation process of transforming the N×N block.

According to an aspect of another exemplary embodiment, there is provided a method of inverse-transforming an image, the method including: obtaining a substituted inverse discrete cosine transformation (IDCT) matrix by substituting values based on a trigonometric function among elements of an N×N inverse-transformation matrix used for one-dimensional IDCT of an N×N block with predetermined rational numbers, wherein the N is an integer; obtaining an upscaling matrix for upscaling elements of the N×N block based on a maximum value of a denominator of an intermediate value generated in a calculation process of inversely transforming the N×N block by using the substituted IDCT matrix; inversely transforming the N×N block by using the upscaling matrix and the substituted IDCT matrix; and downscaling an inversely transformed N×N block based on the maximum value of the denominator of the intermediate value generated in the calculation process of inversely transforming the N×N block.

According to an aspect of still another exemplary embodiment, there is provided an image transformation apparatus including: a transformation unit configured to obtain a substituted discrete cosine transformation (DCT) matrix by substituting values based on a trigonometric function among elements of an N×N transformation matrix used for one-dimensional DCT of an N×N block with predetermined rational numbers, wherein the N is an integer; an upscaling unit configured to upscale the N×N block by using an upscaling matrix obtained based on a maximum value of a denominator of an intermediate value generated in a calculation process of transforming the N×N block by using the substituted DCT matrix; and a downscaling unit configured to downscale a transformed N×N block based on the maximum value of the denominator of the intermediate value generated in the calculation process of transforming the N×N block. The transformation unit transforms the N×N block by using the upscaling matrix and the substituted DCT matrix.

According to an aspect of still another exemplary embodiment, there is provided an image inverse-transformation apparatus including: an inverse-transformation unit for obtaining a substituted inverse discrete cosine transformation (IDCT) matrix by substituting values based on a trigonometric function among elements of an N×N inverse-transformation matrix used for one-dimensional IDCT of an N×N block with predetermined rational numbers, wherein the N is an integer, obtaining an upscaling matrix for upscaling elements of the N×N block based on a maximum value of a denominator of an intermediate value generated in a calculation process of inversely transforming the N×N block by using the substituted IDCT matrix, inversely transforming the N×N block by using the upscaling matrix and the substituted IDCT matrix, and a downscaling unit for downscaling an inversely transformed N×N block based on the maximum value of the denominator of the intermediate value generated in the calculation process of inversely transforming the N×N block.

### BRIEF DESCRIPTION OF THE DRAWINGS

The above and/or other aspects will become more apparent by describing certain exemplary embodiments with reference to the accompanied drawings.

FIG. 1 illustrates an image encoding apparatus according to an exemplary embodiment.

FIG. 2 is a flow graph showing a discrete cosine transformation (DCT) according to an exemplary embodiment.

FIG. 3A is an enlarged diagram of reference numeral 210 of FIG. 2.

FIG. 3B is an enlarged diagram of reference numeral 211 of FIG. 2.

FIG. 4 is a reference view for explaining a calculation process according to a flow graph of reference numeral 212 in the DCT flow graph of FIG. 2.

FIG. 5 is a reference view showing an N-point DCT flow graph for explaining a calculation process according to a flow graph of reference numeral 212 in the DCT flow graph of FIG. 2.

FIG. 6 shows an example in which a flow graph of 32-point DCT as shown in FIG. 2 is divided into three stages.

FIG. 7 shows an example in which a flow graph of 32-point DCT as shown in FIG. 2 is divided into two stages.

FIG. 8 is a block diagram illustrating a structure of a transformation unit, an upscaling unit, and a downscaling unit according to another exemplary embodiment.

FIG. 9 is a flow chart illustrating an image transformation method according to an exemplary embodiment.

FIG. 10 is a flow chart illustrating a quantization process according to an exemplary embodiment.

FIG. 11 is a block diagram illustrating an image decoding apparatus according to an exemplary embodiment.

FIG. 12 is a flow chart illustrating an image inverse-transformation method according to an exemplary embodiment.

FIG. 13 is a flow chart for explaining a process of obtaining an inverse-quantization matrix according to an exemplary embodiment.

### DETAILED DESCRIPTION

Various exemplary embodiments are described in detail with reference to the accompanying drawings.

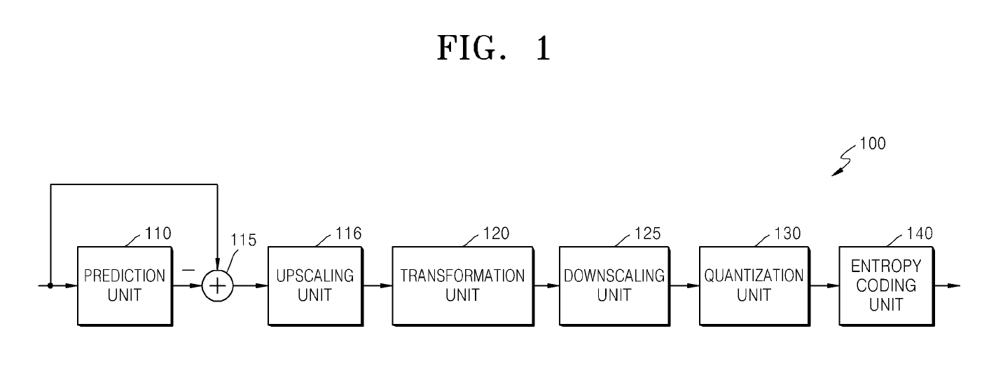

FIG. 1 illustrates an image encoding apparatus 100 according to an exemplary embodiment. Referring to FIG. 1, the image encoding apparatus 100 according to an exemplary embodiment includes a prediction unit 110, a deduction unit 115, an upscaling unit 116, a transformation unit 120, a downscaling unit 125, a quantization unit 130, and an entropy coding unit 140.

The prediction unit 110 divides an input image into a plurality of blocks having a predetermined size and generates a prediction block through inter-prediction or intra-prediction with respect to each divided block. In detail, the prediction unit 110 performs inter-prediction for generating a prediction block through a motion prediction and compensation process of generating a motion vector indicating an area similar to a current block in a predetermined search range of a reference picture that is previously encoded and then restored or intra-prediction for generating a prediction block by using data of surrounding blocks adjacent to the current block.

The deduction unit 115 generates residual where a prediction block of the current block is deducted from original image data.

The upscaling unit 116 upscales a residual signal to be provided as an input signal of the transformation unit 120. Upscaling is to increase an amplitude of an input signal by multiplying an input signal by an upscaling factor having a predetermined magnification rate. As will described later, the transformation unit 120 according to an exemplary embodiment uses a transformation matrix (or substituted matrix) A obtained by substituting a trigonometric function value included in an original discrete cosine transformation (DCT) matrix used in a transformation process with a rational number. However, a denominator component of the rational number in the transformation process corresponds to division calculation or right bit shift calculation (>>) and thus a rounding error may occur in a transformed result value due to the division calculation or the right bit shift calculation (>>). Accordingly, to reduce the rounding error that may occur in the transformation process by the transformation unit 120 and reduce a difference between a result of transformation using the original DCT matrix Original_A and a result of transformation using the substituted DCT matrix A, the upscaling unit 116 according to an exemplary embodiment increases the amplitude of a signal input to the transformation unit 120 considering a maximum value of a denominator of an intermediate value generated during a transformation calculation process. In other words, the upscaling unit 116 removes the denominator component of a rational number corresponding to the division calculation or the right shift calculation (>>) by multiplying the input signal and a scaling factor having a predetermine magnification rate, and thus, a transformation error occurring in the transformation process may be reduced

The transformation unit 120 performs DCT on an upscaled signal from the upscaling unit 116 by using the substituted DCT matrix A in which the trigonometric function values included in the DCT algorithm based on the original N×N transformation matrix Original_A is substituted by rational numbers. In particular, the transform unit 120 generates a transformation coefficient by transforming a signal of an input N×N (N is an integer) block into a frequency domain by using a substituted discrete cosine transform (DCT) matrix A that is obtained by substituting predetermined rational number values for values based on a trigonometric function used in an algorithm, for example, a Loeffler or Chen transform algorithm which performs discrete cosine transformation on an N×N transform matrix or the N×N block used for DCT applicable to a block having a larger size equal to or greater than 16×16. In particular, the rational number used for the substituted DCT matrix A may be a rational number whose denominator is a power of 2 such as q/(2̂p), where p and q are integers. The rational number whose denominator is a power of 2 is used because division calculation corresponding to a rational number may be embodied by using the right bit shift calculation (>>) that has a relatively less load than the division calculation in terms of hardware. In other words, as described above, when a rational number that is q/(2̂p), where p and q are integers, is used as a rational number for substituting the trigonometric function value, a calculation portion corresponding to “1/(2̂p)” may be replaced by “>>p” that performs right bit shift calculation by p bits.

The transformation unit 120 may perform DCT through integer-based addition and subtraction calculations and a bit shift calculation by substituting trigonometric function values of multiplication factors included in the calculation process of a transformation matrix used for DCT with rational numbers. A load may be reduced by replacing a multiplication calculation with a bit shift calculation in view of hardware. Accordingly, complexity in calculation may be reduced and thus a calculation speed related to the transformation process may increase. Further, the transformation unit 120 may modify a calculation process corresponding to a rotational transformation included in the DCT process to include a fewer multiplication operations while having the same result value.

Although FIG. 1 illustrates the upscaling unit 116 and the transformation unit 120 as separate elements, the upscaling unit 116 may be incorporated into the transformation unit 120. In detail, the upscaling unit 116 may perform upscaling by applying, to the input N×N block, an upscaling matrix U obtained based on the maximum value of a denominator of an intermediate value generated in the calculation process of transforming the N×N block by the transformation unit 120. Also, the transformation unit 120 transforms a signal output from the upscaling unit 116 by using the substituted DCT matrix A. When the N×N block input to the upscaling unit 116 is represented as X, the N×N block upscaled by the upscaling unit 116 may be presented as UX and a result value transformed by the transformation unit 120 may be presented as AUX. Thus, the transformation unit 120 may perform an incorporated process of the upscaling process and the transformation process on an input signal by using a matrix product AU of the upscaling matrix U and the substituted DCT matrix A as a DCT matrix.

Thus, the transformation result value based on the upscaled signal is different from the transformation result value of the original signal. Accordingly, the downscaling unit 125 performs downscaling that decreases an amount of the transformation result value output from the transformation unit 120. The downscaling unit 125 may perform downscaling by dividing the output signal of the transformation unit 120 by the scaling factor by which the input signal is multiplied in the upscaling unit 116. An operation of the downscaling unit 125 may be incorporated into a scaling operation by the quantization unit 130 that compensates for a difference in the transformation result value between the substituted DCT matrix A and the original DCT matrix Original_A, as will be described later.

The quantization unit 130 quantizes the transformation value downscaled by the downscaling unit 125. In particular, the quantization unit 130 according to an exemplary embodiment may reduce an error between a value obtained by transforming an input signal by using a DCT matrix approximated by the transformation unit 120 and a value obtained by transforming an input signal by using the original DCT matrix, by incorporating a quantization process using a quantization step Qstep and a scaling process of transformation coefficients output from the transformation unit 120. The quantization unit 130 generates a scaling matrix S based on a size of each element in the substituted DCT matrix A and generates a quantization matrix MF including the scaling process based on the scaling matrix S. As will be described later, the scaling matrix S is a matrix having elements that are reciprocal numbers of square roots of elements that are in a main diagonal of a matrix product AA^{T} of the substituted DCT matrix A and a transposed matrix A^{T} of the substituted DCT matrix A. The quantization unit 130 performs the scaling process and the quantization process by applying the quantization matrix MF and the quantization step Qstep to the transformation value output from the transformation unit 120.

Although FIG. 1 illustrates the downscaling unit 125 and the quantization unit 130 to be separate elements, the downscaling unit 125 may be incorporated into the quantization unit 130. As will be described later, the quantization unit 130 obtains the scaling matrix S by using the substituted DCT matrix A and the transposed matrix A^{T} of the substituted DCT matrix A and obtains the quantization matrix MF based on the scaling matrix S and the quantization step Qstep. The downscaling unit 125 may incorporate the scaling factor that divides the output value of the transformation unit 120 into the quantization matrix MF. In other words, when the transformation value input to the downscaling unit 125 is represented as X and the scaling factor dividing the transformation value X in the downscaling unit 125 is represented as D, a signal downscaled by the downscaling unit 125 may be presented as X/D and a result value quantized by the quantization unit 130 may be presented as MF*X/D. Since the same result value may be obtained in a process of (MF/D)*X, the downscaling unit 125 may be incorporated into the quantization unit 130 to device the quantization matrix MF applied to the quantization unit 130 by the scaling factor D. When a rational number whose denominator is a power of 2 is used as the rational number used for the substituted DCT matrix A, the scaling factor S has a power of 2 as well and the downscaling may be embodied in a simple manner by using the right bit shift calculation (>>).

The entropy coding unit 140 performs variable length coding on the quantized image data to generate a bitstream.

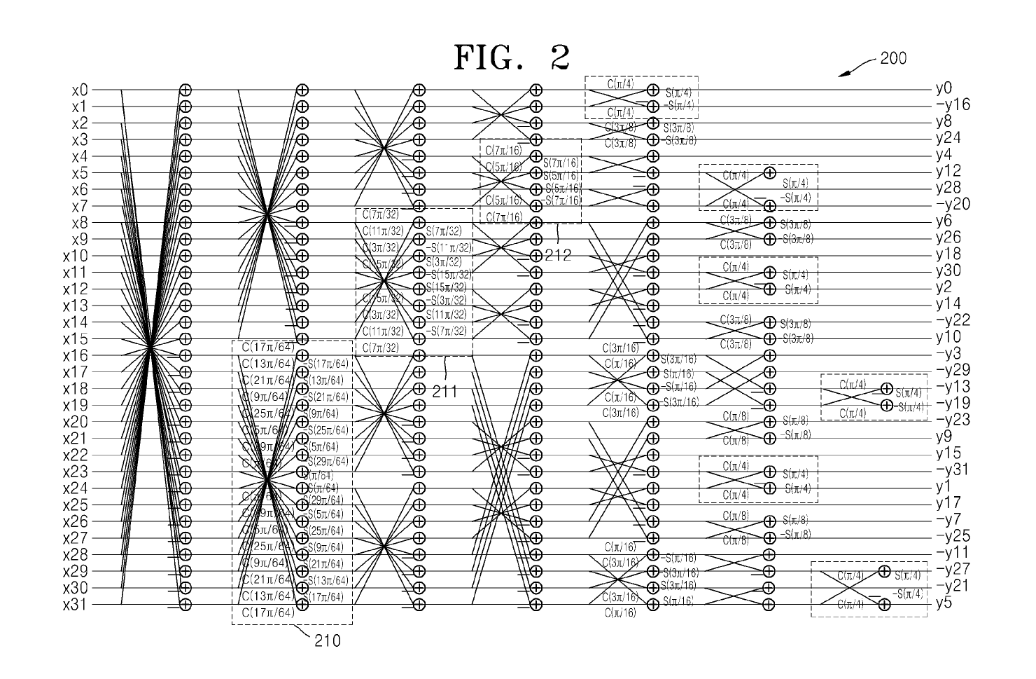

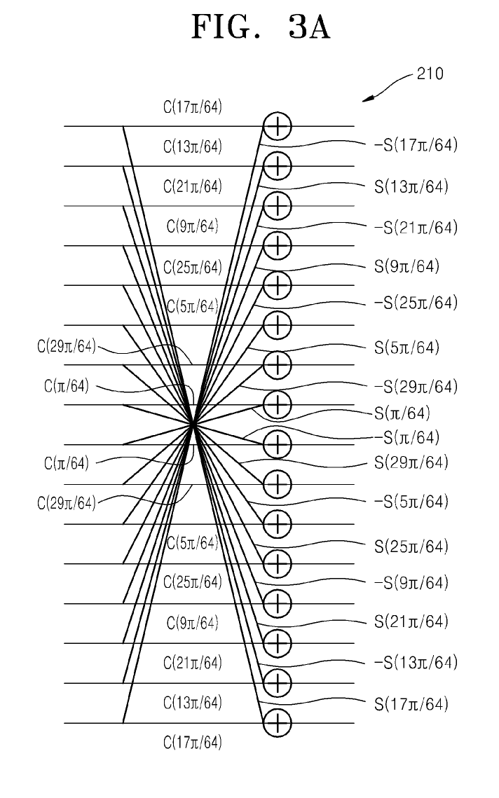

The method of transforming an image according to an exemplary embodiment will be described below in detail. FIG. 2 is a flow graph showing a DCT according to an exemplary embodiment. FIG. 3A is an enlarged diagram of reference numeral 210 of FIG. 2. FIG. 3B is an enlarged diagram of reference numeral 211 of FIG. 2.

A flow graph of a 32-point DCT in FIG. 2 may be obtained from a 16-point DCT algorithm by using characteristics of a DCT matrix in which components in even-numbered rows, i.e., the 0th row, the 2nd row, . . . , are symmetric and components in odd-numbered rows, i.e., the 1st row, the 3rd row, . . . , are anti-symmetric in an N-point DCT matrix. Similarly, a 64-point DCT flow graph, a 128-point DCT flow graph, a 256-point DCT flow graph, etc. may be obtained from the 32-point DCT flow graph of FIG. 2.

Referring to FIGS. 2, 3A, and 3B, x0 to x31 and y0 to y31 indicate input values of a DCT and output values of a DCT, respectively. In an inverse-DCT (IDCT), x0 to x31 and y0 to y31 indicate output values of the IDCT and input values of the IDCT, respectively. A data process direction in the DCT is from left to right and a data process direction in the IDCT is from right to left. A value on each line indicates a multiplication factor by which a value passing through each line is multiplied. Cθ and Sθ indicate cos θ and sin θ respectively. A sign “−” on a line signifies that a multiplication factor of “−1” is applied to a corresponding line, that is, a signal passing through the corresponding line is multiplied by −1. Since a calculation of multiplying by −1 may be performed by a bit calculation, the calculation is simple compared to when a multiplication factor whose absolute value is not 1.

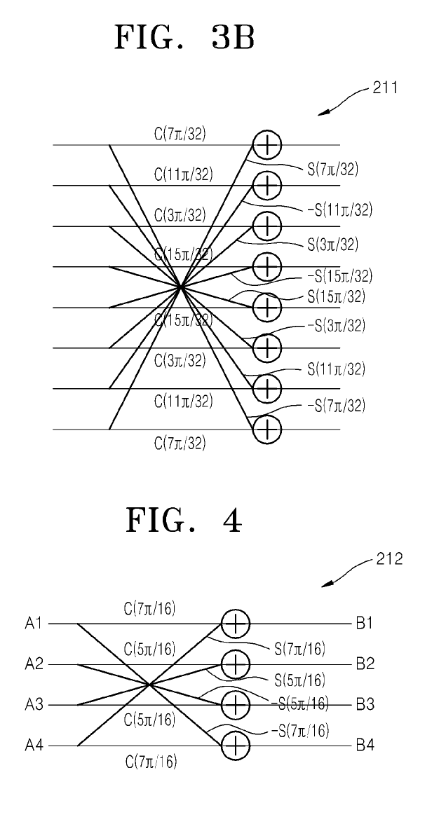

FIG. 4 is a reference view for explaining a calculation process according to a flow graph of reference numeral 212 in the DCT flow graph of FIG. 2. Referring to FIG. 4, when input signals A1 to A4 are input, output values B1 to B4 may be obtained by using the following equations:

B1=A1*C(7π/16)+A4*S(7π/16)

B2=A2*C(5π/16)+A3*S(5π/16)

B3=A2*S(5π/16)+A3*C(5π/16)

B4=A1*S(7π/16)+A4*C(7π/16)

Similarly, a DCT may be performed by performing calculation processes such as multiplication, addition, and subtraction with respect to an input signal for each line according to the flow graph of FIG. 2.

A DCT according to a DCT flow graph 200 may be disadvantageous in that Cθ and Sθ may be irrational numbers according to the value of θ, and thus, calculation complexity may increase. In other words, a DCT process includes a floating point calculation according to a trigonometric function value and thus calculation complexity may increase. Accordingly, in an image transformation method according to an exemplary embodiment, a trigonometric function value used for a DCT is approximated and substituted by a rational number and a DCT is performed by using a substituted DCT matrix. Therefore, a result value that is substantially similar to the original DCT through scaling in the quantization process may be produced.

According to an exemplary embodiment, the transformation unit 120 substitutes the trigonometric function values included in a DCT algorithm based on the original N×N transformation matrix Original_A with rational numbers. In particular, the transformation unit 120 substitutes the trigonometric function value with a rational number whose denominator is a power of 2 such as q/(2̂p), where p and q are integers. P is a precision value. As p increases, expression of a finer value is possible so that the trigonometric function value may be more precisely approximated by a rational number. When a DCT process is performed by substituting the denominator of the trigonometric function value with the rational number whose denominator is a power of 2, the calculation process using the rational number whose denominator is a power of 2 may be performed by a bit shift calculation instead of a division calculation and thus calculation complexity decreases.

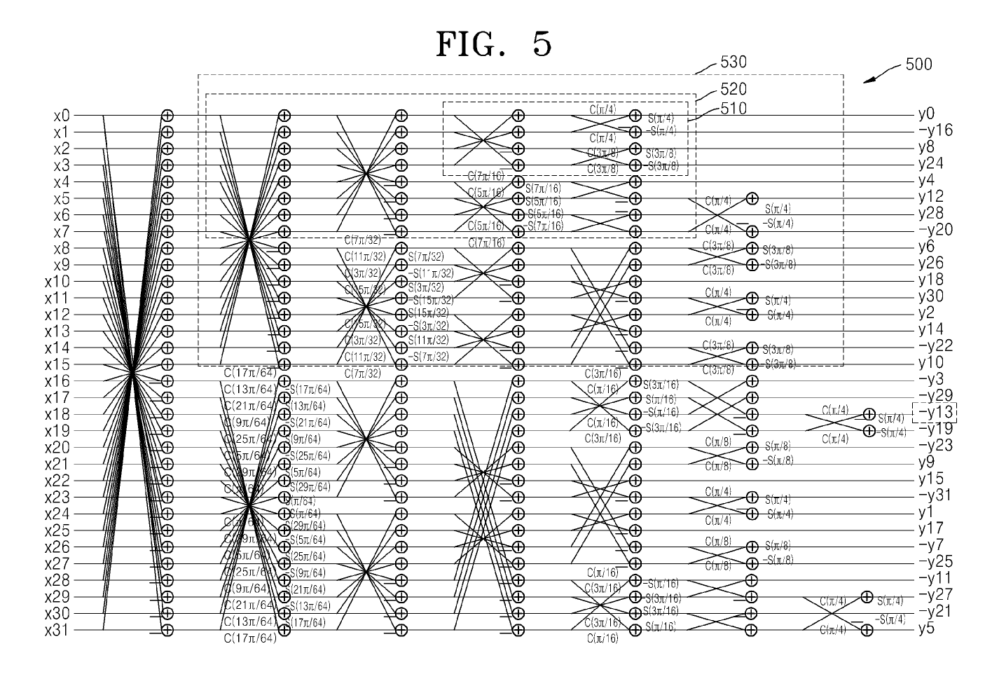

FIG. 5 is a reference view showing an N-point DCT flow graph for explaining a calculation process according to a flow graph of reference numeral 212 in the DCT flow graph of FIG. 2. FIG. 5 illustrates flow graph structures of 4-point, 8-point, 16-point, and 32-point DCTs based on the flow graph of FIG. 2.

Referring to FIG. 5, a portion 510 indicated by a dotted line indicates a flow graph of 4-point one-dimensional transformation, a portion 520 indicated by a dotted line indicates a flow graph of 8-point one-dimensional transformation, a portion 530 indicated by a dotted line indicates a flow graph of 16-point one-dimensional transformation, and a portion 500 indicated by a dotted line indicates a flow graph of 32-point one-dimensional transformation.

As described above, when the transformation is performed by substituting the trigonometric function value with a rational number whose denominator is a power of 2 such as q/(2̂p), the calculation complexity decreases and the calculation speed increases. Referring to the 32-point DCT flow graph 500 of the N-point DCT flow graph of FIG. 5, output values are consecutively multiplied by maximum three cos and sin values. In detail, when the output values y13, y19, y27, and y5 are obtained, the signal is multiplied by the maximum three cos and sin values. For example, when a unit vector value of [1, 0, . . . , 0] is input as an input value of [x0, x1, . . . , x31], the output value y13 is obtained by the following equation:

y13=c(π/4)*c(3π/16)*s(17π/64)+c(π/4)*c(17π/64)*s(3π/16)+s(π/4)*c(3π/16)*c(17π/64)−s(π/4)*s(3π/16)*s(17π/64).

The number of the consecutive multiplications in the 32-point DCT process according to the flow graphic 500 of FIG. 5 is three times at its maximum. When p, which is the rational number used for the substituted 32-point DCT matrix A, is 6, a trigonometric function value is substituted by a rational number having 2̂6 as a denominator, and the maximum value of the denominator of an intermediate value generated during the transformation process is (2̂(6*3)). For example, referring to the above equation for obtaining the output value y13, when a calculation is performed by substituting each trigonometric function value with a rational number that is q/(2̂6), c(π/4)*c(3π/16)*s(17π/64) has a form of x/(2̂(6*3)), where x is an integer, c(π/4)*c(17π/64)*s(3π/16)+s(π/4)*c(3π/16)*c(17π/64) has a form of y/(2̂(6*3)), where y is an integer, and s(π/4)*s(3π/16)*s(17π/64) has a form of z/(2̂(6*3)), where z is an integer. As a result, the output value y13 is represented by the mathematical expression y13=x/(2̂(6*3))+y/(2̂(6*3))+z/(2̂(6*3)). In this case, the upscaling unit 116 performs multiplication of a value (2̂(6*3)) on an input signal so that the transformation calculation process may be simplified to a form of y13′=x+y+z.

When the intermediate value generated in the transformation process using the substituted DCT matrix A includes a multiplication process of a maximum K number of rational numbers whose denominator is 2̂p, where K is an integer, the upscaling unit 116 may obtain the upscaling matrix U obtained by multiplying an N×N unit matrix by a value of 2̂(K*p) and apply the obtained upscaling matrix to an N-point input signal, thereby performing upscaling. As described above, when the matrix product AU of the substituted DCT matrix A and the upscaling matrix U by the transformation unit 120 is used as a DCT matrix, the upscaling may be incorporated into and performed by the transformation process.

Also, in a downscaling process corresponding to the upscaling process, when the intermediate value generated in the transformation process using the substituted DCT matrix A, as in the above-described upscaling process, includes a multiplication process of rational numbers whose denominators are 2̂p and the maximum number of multiplication process of rational numbers is K, the downscaling unit 125 may perform downscaling by dividing the output value of the transformation unit 120, that is, N×N transformation block, by a value of 2̂(K*p). As described above, the downscaling operation may be incorporated into the quantization process by the quantization unit 130.

Although the 32-point DCT structure is mainly discussed in the above-described example, the upscaling process with respect to a signal input to the transformation unit 120 and the downscaling process with respect to a signal output from the transformation unit 120 according to an exemplary embodiment may be applied to other point DCT structures.

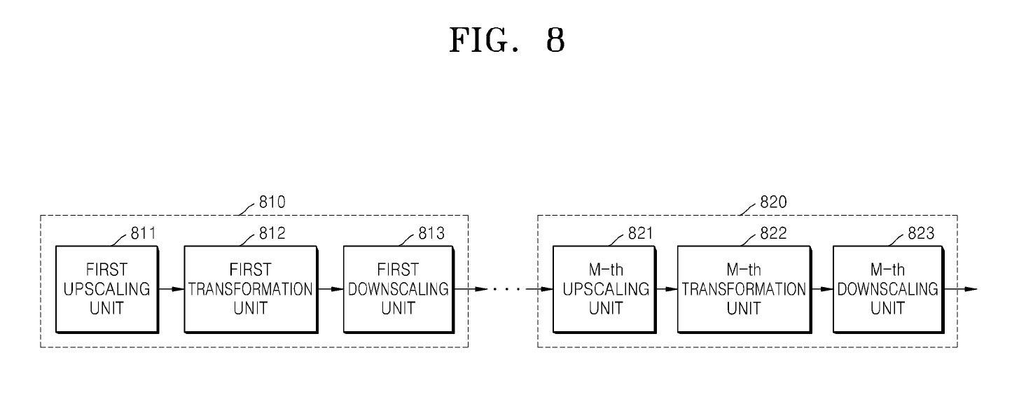

FIG. 8 is a block diagram illustrating a structure of a transformation unit, an upscaling unit, and a downscaling unit according to an exemplary embodiment. When a signal input to the transformation unit 120 is upscaled according to an exemplary embodiment as described above, a bit depth increases and thus overflow may occur in the calculation process of the transformation unit 120. Accordingly, according to another exemplary embodiment, the transformation process is divided into M-number of transformation stages, where M is an integer, and a signal input for each of the M-number of transformation stages is upscaled and a signal output for each of the M-number of transformation stages is downscaled. Thus, overflow of a single that may occur in the transformation process may be substantially prevented.

When the substituted DCT matrix A is factorized into M-number of transformation matrixes, the upscaling unit 116, the transformation unit 120, and the downscaling unit 125 of FIG. 1 may be reconfigured into M-number of transformation stages 810 and 820, as illustrated in FIG. 8. The M-number of transformation stages 810 and 820 respectively include first to M-th upscaling units 811 and 821 for upscaling input values, first to M-th transformation units 812 and 822 for performing transformation based on the factorized transformation matrix, and first to M-th downscaling units 813 and 823 for downscaling output values of the M-number of transformation units 812 and 822. The M-number of transformation units 812 and 822 each determine a scaling factor considering the maximum value of a denominator generated in the calculation process by the corresponding M-number of transformation units 812 and 822 and perform upscaling by multiplying a determined scaling factor and an input value. As described above, when the intermediate value generated in the transformation process by a corresponding transformation unit includes a multiplication process of rational numbers whose denominator is 2̂p, the maximum number of multiplication of the rational numbers being K, each of the M-number of upscaling units 811 and 821 corresponding to the M-number of transformation units 812 and 822 may perform upscaling by applying the upscaling matrix U, which is obtained by multiplying the N×N unit matrix by a value of 2̂(K*p), to an N-point input signal. The M-number of downscaling unit 813 and 823 each may perform downscaling by dividing the output values of the corresponding transformation units by the value of 2̂(K*p).

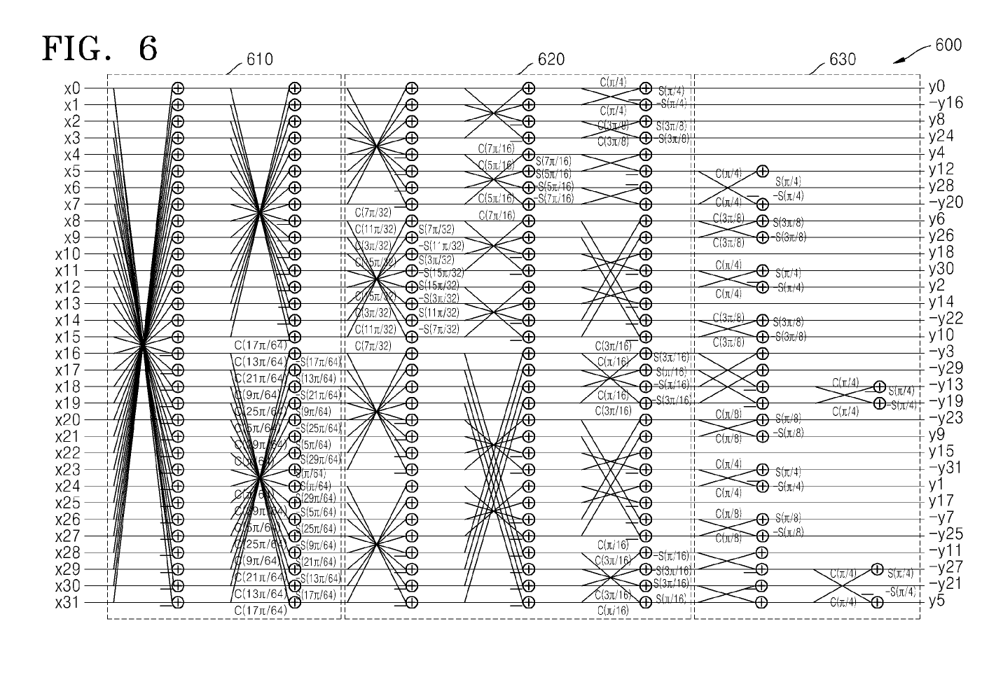

FIG. 6 shows an example in which a flow graph of 32-point DCT as shown in FIG. 2 is divided into three stages. Referring to FIG. 6, when a 32-point DCT flow graph 600 is factorized into three transformation stages 610, 620, and 630, the sin and cos values are multiplied by an input signal only once in the calculation process of each of the transformation stages 610, 620, and 630. Accordingly, upscaling is performed in each transformation stage by multiplying an input signal of each transformation stage by a value of 2̂(1*p), whereas downscaling is performed in each transformation stage by dividing an output signal of each transformation stage by the value of 2̂(1*p). As described above, the multiplication and division calculations using a power of 2 may be embodied by a left bit shift calculation (>>) and a right bit shift calculation (<<), respectively.

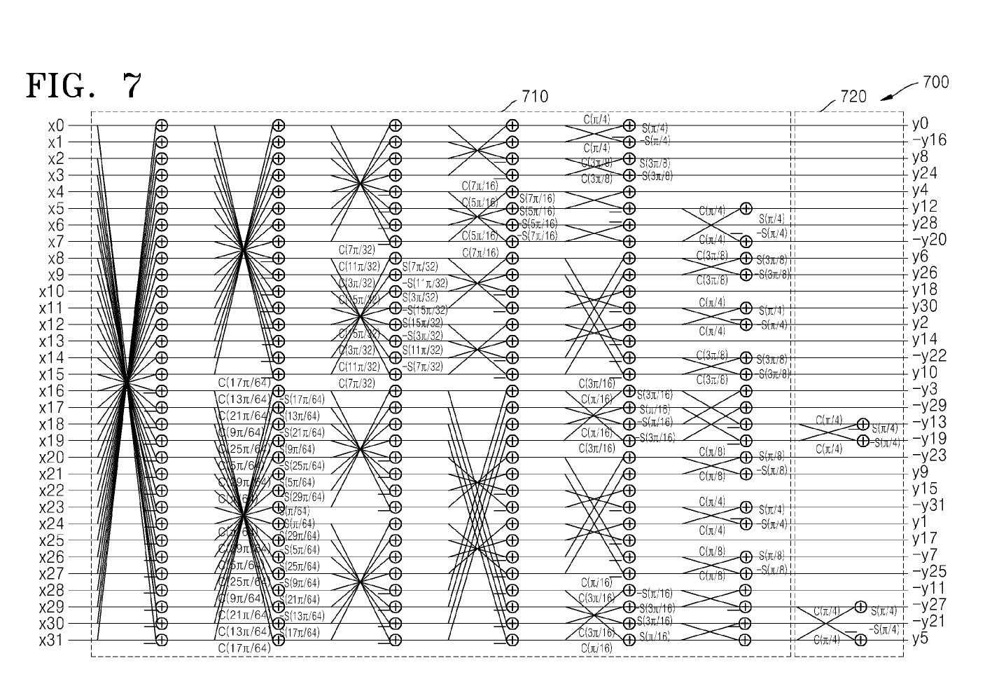

FIG. 7 shows an example in which a flow graph of 32-point DCT as shown in FIG. 2 is divided into two stages. Referring to FIG. 7, when a 32-point DCT flow graph 700 is factorized into two transformation stages 710 and 720, two sin and cos values are consecutively multiplied by an input signal in the first transformation stage 710. Accordingly, upscaling is performed by multiplying an input signal of the first transformation stage 710 by a value of 2̂(2*p), whereas downscaling is performed by dividing an output signal of the first transformation stage 710 by the value of 2̂(2*p). In the second transformation stage 720, only the output values y5, y13, y19, and y27 among the output values of the first transformation stage 710 are changed. Accordingly, when the 32-point DCT flow graph is factorized into the two transformation stages 710 and 720, the other output value except for the output values y5, y13, y19, and y27 are obtained by using result values of the first transformation stage 710. The output values y5, y13, y19, and y27 may be obtained according to the following equations, instead of the transformation process by the second transformation stage 720.

y13=c(π/4)*(y′(13)−y′(19))

y19=c(π/4)*(y′(13)+y′(19))

y27=c(π/4)*(y′(27)−y′(5))

y5=c(π/4)*(y′(27)+y′(5))

In the above equations, y′(5), y′(13), y′(19), and y′(27) denote output signals of the first transformation stage 710 connected to the output values y5, y13, y19, and y27. Also, since c(π/4)=s(π/4), the transformation process by the second transformation stage 720 may be determined as shown by the above equations.

If c(π/4) is substituted by q/(2̂p), the above equations may be expressed as follows.

y13=q*(y′(13)−y′(19))>>p;

y19=q*(y′(13)+y′(19))>>p;

y27=q*(y′(27)−y′(5))>>p; and

y5=q*(y′(27)+y′(5))>>p.

Since p and q are integers, the transformation process by the second transformation stage 720 may be embodied by addition, subtraction, bit shift calculations, and the one-time multiplication calculation of multiplying q.

When the trigonometric function value included in a DCT matrix is substituted by a rational number in the transformation unit 120 or a calculation structure in which the number of multiplication calculations is reduced is employed, the DCT algorithms are modified and thus a difference may occur between the result values of the original DCT algorithms and the result values of the modified DCT algorithms. Accordingly, the quantization unit 130 according to an exemplary embodiment reduces a transformation error by applying a scaling matrix to the scaling process that is performed together with the quantization process to use the substituted DCT algorithms.

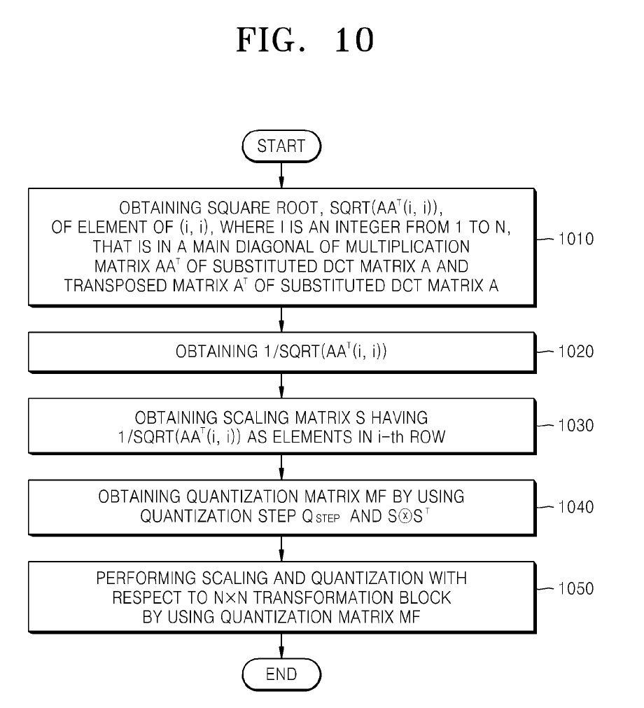

FIG. 10 is a flow chart for explaining a quantization process according to an exemplary embodiment. Referring to FIGS. 1 and 10, in operation 1010, the quantization unit 130 obtains a square root, sqrt(AA^{T}(i, i)), of an element of (i, i), where i is an integer from 1 to N, that is in a main diagonal of the matrix product AA^{T} of the substituted DCT matrix A and the transposed matrix A^{T} of the substituted DCT matrix A. In operation 1020, the quantization unit 130 obtains a reciprocal of sqrt(AA^{T}(i, i)), that is, 1/sqrt(AA^{T}(i, i)). In operation 1030, the quantization unit 130 obtains a scaling matrix S having 1/sqrt(AA^{T}(i, i)) as elements in an i-th row. When 1/sqrt(AA^{T}(i, i)) is s(i), the quantization unit 130 generates the scaling matrix S having all elements in the i-th row as s(i). In operation 1040, the quantization unit 130 obtains the quantization matrix MF by using the quantization step Qstep and a matrix S [symbol] S^{T} obtained by multiplying elements of the scaling matrix S by elements of the reciprocal matrix S^{T} of the scaling matrix S each located at the same positions. The sign [symbol] denotes an element-by-element multiplication or element-wise multiplication, that is, a calculation of multiplying elements located at the same positions between matrixes.

In detail, when a matrix PF, i.e., S [symbol] S^{T} obtained by multiplying an element of the scaling matrix S and the element of the reciprocal matrix S^{T} of the scaling matrix S, the elements being located at the same positions, the quantization matrix MF may be obtained through an equation that MF=PF*2̂m/Qstep. The Qstep is a quantization step and m is a positive integer. For example, m=10. The quantization matrix MF is defined with respect to initial six steps of Qstep values 0.625, 0.6875, 0.8125, 0.875, 1, and 1.25 without defining all quantization steps. This is because, when a quantization parameter QP is increased by 6, the quantization step Qstep is increased twice. Accordingly, the quantization matrix MF may be defined with respect to the initial 6 steps of Qstep values and the quantization matrix MF according to other QPs may be selected according to a (QP mod 6) value.

Also, the quantization unit 130 according to another exemplary embodiment may obtain the quantization matrix MF in consideration of an error occurring by approximating the PF, through an equation MF=round(PF*2̂m*PF*2̂n·/V).

In operation 1050, the quantization unit 130 performs scaling and quantization with respect to the N×N transformation block by using the quantization matrix MF. In detail, the quantization unit 130 determines a size of a transformation coefficient that is quantized by bit-shift a value, which is obtained by adding a predetermined offset to a value obtained by multiplying an element of the quantization matrix MF and an element of the N×N transformation block, the elements being located at the same positions, by a q bit in an equation q=floor(QP/6)+m, where QP is a quantization parameter. In other words, when the quantized transformation coefficient value is represented as Zij, the transformation coefficient output from the transformation unit 120 is represented as Wij, and an offset is represented as f, the size of the quantized transformation coefficient is determined according to an equation |Zij|=(|Wij|·MF+f)>>. A sign of the quantized transformation coefficient is determined according to an equation sign(|Zij|)=sign (|Wij|). Here, ‘·MF’ denotes a vector multiplication that multiplies elements in the same position of a matrix. As described above, the vector multiplication may be expressed by the sign “ [symbol] ”. In the quantization process of operation 1050, a process of multiplying the elements of the quantization matrix MF and the elements of the N×N transformation block, the elements being located at the same positions, corresponds to the scaling process and the process of performing a right bit shift calculation by the q bit corresponds to the quantization process. As described above, the downscaling process of dividing the output value of the transformation unit 120 by the scaling factor in the downscaling unit 125 may be incorporated into the quantization process by the quantization unit 130. In other words, the downscaling and the quantization process may be performed altogether by dividing the quantization matrix MF by the determined scaling factor.

As described above, the quantization unit 130 stores the quantization matrix MF in a predetermined memory and performs quantization through a matrix calculation with a transformation value. When transformation is performed in unit of a block having a larger size in an exemplary embodiment, the size of the quantization matrix MF increases and thus a memory capacity for storing the quantization matrix MF needs to increase. Accordingly, to reduce the memory capacity needed for the quantization process, the quantization unit 130 according to another exemplary embodiment may perform quantization through a scalar calculation using a direct current (DC) value or an average value of the quantization matrix MF. In detail, the quantization unit 130 may define the DC value or the average value of the quantization matrix MF according to the (QP mod 6) value and perform quantization by using the average value of the quantization matrix MF determined according to the (QP mod 6) value. For example, when an average value MF_AVG of the quantization matrix MF that is a scalar value is defined to be {222, 202, 171, 159, 139, 123} according to the (QP mod 6) value, the quantization unit 130 may select one of the MF_AVG values according to the (QP mod 6) value and determine the size of the quantized transformation coefficient according to an equation |Zij|=(|Wij|*MF_AVG+f)>>qbits.

In an inverse-transformation process, to reduce a memory capacity needed for the inverse-transformation process instead of a matrix calculation using an inverse-quantization matrix V, a DC value or an average value of the inverse-quantization matrix V may be defined according to the (QP mod 6) value and inverse-quantization may be performed by using the DC value or the average value of the inverse-quantization matrix V determined according to the (QP mod 6) value. For example, when the average value V_AVG of the inverse-quantization matrix V that is a scalar value is defined to be {87, 95, 113, 121, 139, 156} according to the (QP mod 6) value, Wij is obtained by inverse-quantizing the coefficient Zij that is quantized through an equation Wij=(Zij*V_AVG)<<floor(QP/6), wherein the V_AVG value is selected according to the (QP mod 6) value.

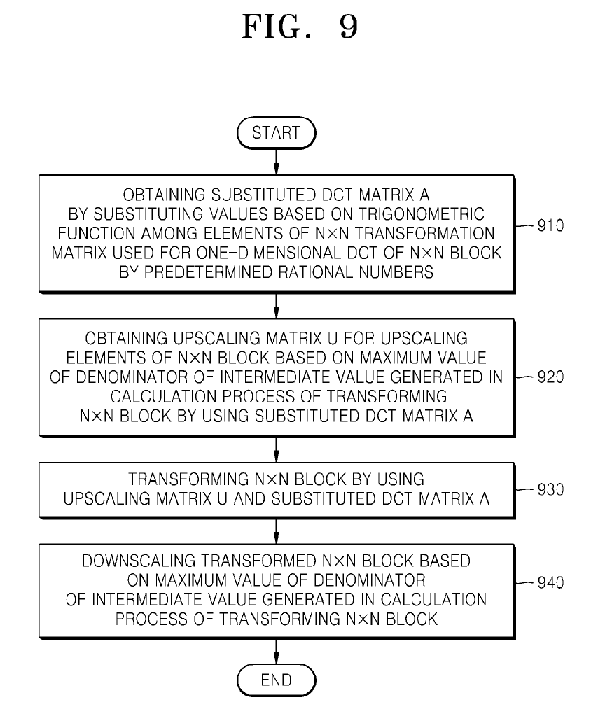

FIG. 9 is a flow chart illustrating an image transformation method according to an exemplary embodiment. Referring to FIG. 9, in operation 910, the transformation unit 120 substitutes values based on a trigonometric function among elements of an N×N transformation matrix used for one-dimensional DCT of an N×N block, where N is an integer, with predetermined rational numbers, and obtains the substituted DCT matrix A.

In operation 920, the upscaling unit 116 obtains the upscaling matrix U for upscaling the elements of the N×N block based on the maximum value of a denominator of an intermediate value generated in the calculation process of transforming the N×N block by using the substituted DCT matrix A. As described above, when the intermediate value generated in the transformation process using the substituted DCT matrix A includes a multiplication process of rational numbers whose denominator is 2̂p, the maximum number of the multiplication process of the rational numbers being K, where K is an integer, the upscaling matrix U may be a matrix of multiplying an N×N unit matrix and a value of 2̂(K*p).

In operation 930, the transformation unit 120 transforms the N×N block by using the upscaling matrix U and the substituted DCT matrix A. As described above, the upscaling operation by the upscaling unit 116 may be incorporated into the transformation operation by the transformation unit 120. In this case, the transformation unit 120 may perform the upscaling and transformation operations with respect to an input signal by using a value of AU obtained by multiplying the substituted DCT matrix A and the upscaling matrix U.

In operation 940, the downscaling unit 125 downscales a transformed N×N block based on the maximum value of the denominator of the intermediate value generated in the calculation process of transforming the N×N block. When the intermediate value generated in the transformation process using the substituted DCT matrix A includes a multiplication process of rational numbers whose denominator is 2̂p, the maximum number of the multiplication process of the rational numbers being K, where K is an integer, the downscaling unit 125 may perform downscaling by dividing the N×N transformation block by the value of 2̂(K*p).

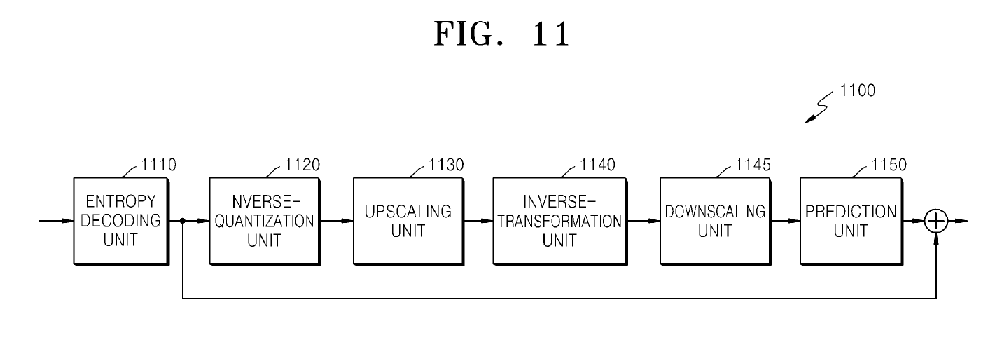

FIG. 11 is a block diagram illustrating an image decoding apparatus 1100 according to an exemplary embodiment. Referring to FIG. 11, the image decoding apparatus 1100 according to an exemplary embodiment includes an entropy decoding unit 1110, an inverse-quantization unit 1120, an upscaling unit 1130, an inverse-transformation unit 1140, a downscaling unit 1145, and a prediction unit 1150.

The entropy decoding unit 1110 extracts prediction mode information, reference picture information, and residual information of a current block that is decoded from an input bitstream. The residual information corresponds to a quantized transformation coefficient.

The inverse-quantization unit 1120 performs inverse-quantization on the quantized transformation coefficients extracted by the entropy decoding unit 1110. In detail, the inverse-quantization unit 1120 performs inverse-quantization on the transformed and quantized N×N block input to the inverse-transformation unit 1140 by using the scaling matrix S and the quantization step Qstep for compensating for a difference in the result value between a substituted IDCT matrix B and an original IDCT matrix Original_B by using the substituted IDCT matrix B and a transposed matrix B^{T} of the substituted IDCT matrix B.

The scaling matrix S may be a matrix having 1/sqrt(BB^{T}(i, i)) as elements in an i-th row wherein 1/sqrt(BB^{T}(i, i)) is a square root of an element located at (i, i), where i is an integer from 1 to N, that is in a main diagonal of a matrix product BB^{T} of the substituted IDCT matrix B and the transposed matrix B^{T} of the substituted IDCT matrix B. The inverse-quantization unit 1120 may obtain an inverse-quantization matrix V based on the PF that is the matrix S\textcircled{×}S^{T} obtained by multiplying the elements of the scaling matrix S and the element of the reciprocal matrix S^{T} of the scaling matrix S, the elements being located at the same positions. In detail, the inverse-quantization matrix V may be obtained through an equation V=Qstep*PF*2̂n, where n is an integer. Also, according to another exemplary embodiment, the inverse-quantization unit 1120 may obtain the inverse-quantization matrix V by an equation V=round(Qstep*PF*2̂n), where n is an integer, to reduce complexity of a calculation by the PF having a floating point number.

When the inverse-quantization matrix V is determined, the inverse-quantization unit 1120 performs inverse-quantization by left bit shifting a value obtained by multiplying an element of the inverse-quantization matrix V and an element of the N×N transformation block, the elements being located at the same positions, by a floor(QP/6), where floor[x] is an integer that is equal to or less than x and QP is a quantization parameter. In other words, when Zij represents a quantized transformation coefficient and Wij represents an inversely quantized transformation coefficient, the inverse-quantization unit 1120 may obtain Wij obtained by inversely quantizing the quantized coefficient Zij through an equation that Wij=(Zij·V)<<floor(QP/6).

The upscaling unit 1130 upscales the quantized transformation signal that is input to the inverse-transformation unit 1140, similarly to the upscaling unit 116 of FIG. 1. In other words, when an intermediate value generated in the inverse-transformation process using the substituted IDCT matrix B includes a multiplication process of rational numbers whose denominator is 2̂p, the maximum number of the multiplication process of the rational numbers being K, where K is an integer, the upscaling unit 1130 may perform upscaling by multiplying an input signal and a value of 2̂(K*p) and the downscaling unit 1145 may perform downscaling by dividing an output value of the inverse-transformation unit 1140 by the value of 2̂(K*p). As described above, the multiplication and division operations using a power of 2 may be embodied by bit shift calculation (<< or >>). Also, the upscaling unit 1140 may be incorporated into the inverse-quantization unit 1120. In other words, similar to the above-described incorporation of the upscaling unit 116 and the transformation unit 120, upscaling may be performed in the inverse-quantization process by using a matrix product UV of the upscaling matrix U and the inverse-quantization matrix V used for the inverse-quantization process.

The inverse-transformation unit 1140 inversely transforms the inversely quantized transformation coefficients by using the substituted IDCT matrix B obtained by substituting values based on a trigonometric function among the elements of the N×N IDCT matrix Original_B by predetermined rational numbers. As a result of the inverse-transformation, residual values with respect to a block unit are restored.

The downscaling unit 1145 downscales an inversely transformed N×N block by dividing an inversely transformed signal output from the inverse-transformation unit 1140 by a scaling factor based on the maximum value of a denominator of the intermediate value generated in the calculation process of inversely transforming the N×N block. In other words, when the intermediate value generated in the inverse-transformation process using the substituted IDCT matrix B includes a multiplication process of rational numbers whose denominator is 2̂p, the maximum number of the multiplication process of the rational numbers being K, where K is an integer, the downscaling unit 1145 may perform downscaling by dividing the output value of the inverse-transformation unit 1140 by the value of 2̂(K*p). Also, the downscaling unit 1145 may be incorporated into the inverse-transformation unit 1140. In other words, downscaling may be performed in the inverse-transformation process by being incorporated therein by using a new inverse-transformation matrix B/D in the inverse-transformation process based on the inverse-transformation matrix B used for the inverse-transformation process and the scaling factor D used for the downscaling process.

The prediction unit 1150 generates a prediction value based on prediction mode information. An image is restored by adding the prediction value and a downscaled residual signal that is restored by the inverse-transformation unit 1130.

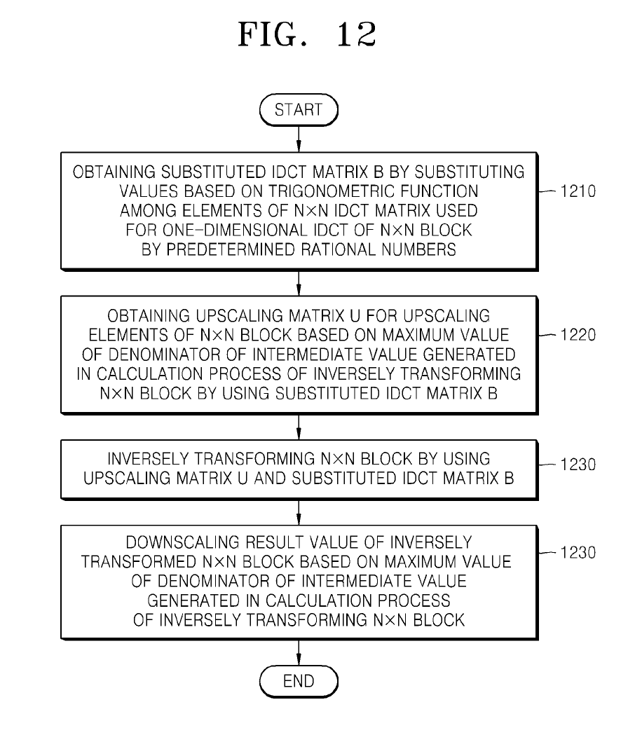

FIG. 12 is a flow chart illustrating an image inverse-transformation method according to an exemplary embodiment. Referring to FIG. 12, in operation 1210, the inverse-transformation unit 1140 obtains the substituted IDCT matrix B by substituting values based on a trigonometric function among the elements of the N×N IDCT matrix used for the one-dimensional IDCT of an N×N block, where N is an integer, by predetermined rational numbers.

In operation 1220, the upscaling unit 1130 obtains the upscaling matrix U for upscaling the elements of the N×N block based on the maximum value of the denominator of the intermediate value generated in the calculation process of inversely transforming the N×N block by using the substituted IDCT matrix B.

In operation 1230, the inverse-transformation unit 1140 inversely transforms the N×N block by using the upscaling matrix U and the substituted IDCT matrix B.

In operation 1240, the downscaling unit 1145 downscales the inversely transformed N×N block based on the maximum value of the denominator of the intermediate value generated in the calculation process of inversely transforming the N×N block.

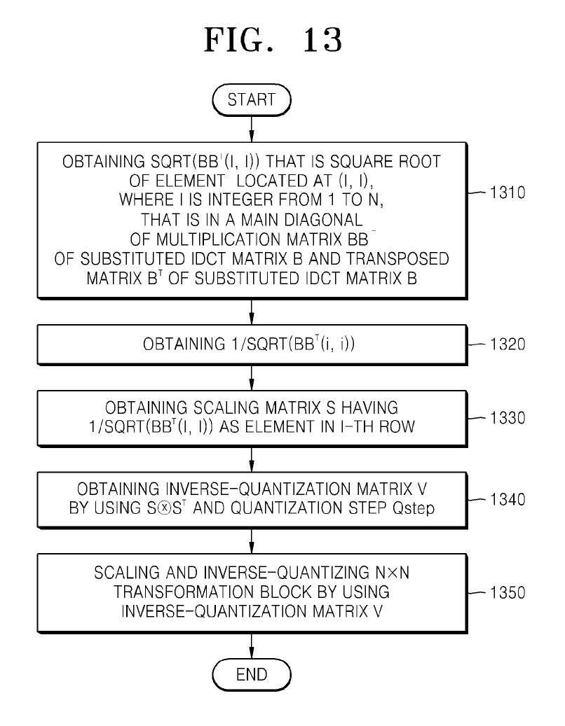

FIG. 13 is a flow chart illustrating a process of obtaining the inverse-quantization matrix V according to an exemplary embodiment. Referring to FIG. 13, in operation 1310, the inverse-quantization unit 1120 obtains sqrt(BB^{T}(i, i)) that is a square root of an element located at (i, i), where i is an integer from 1 to N, that is in a main diagonal of the matrix product BB^{T} of the substituted IDCT matrix B and the transposed matrix B^{T} of the substituted IDCT matrix B.

In operation 1320, the inverse-quantization unit 1120 obtains 1/sqrt(BB^{T}(i, i)) that is a reciprocal of sqrt(BB^{T}(i, i)). In operation 1330, the inverse-quantization unit 1120 obtains the scaling matrix S having 1/sqrt(BB^{T}(i, i)) as an element in the i-th row.

In operation 1340, the inverse-quantization unit 1120 generates the inverse-quantization matrix V based on the PF that is the matrix S [symbol] S^{T} obtained by multiplying the element of the scaling matrix S and the element of the reciprocal matrix S^{T} of the scaling matrix S, the elements being located at the same positions. In detail, the inverse-quantization matrix V may be obtained by an equation V=Qstep*PF*2̂n, where n is an integer.

In operation 1350, the inverse-quantization unit 1120 performs scaling and inverse-quantization by left shifting a value obtained by multiplying an element of the inverse-quantization matrix V and an element of the quantized N×N transformation block, the elements being located at the same positions, by a floor(QP/6), where floor[x] is an integer that is equal to or less than x and QP is a quantization parameter. In other words, when Zij represents a quantized transformation coefficient and Wij represents an inversely quantized transformation coefficient, the inverse-quantization unit 1120 may obtain Wij that is obtained by inversely quantizing the quantized coefficient Zij, through an equation Wij=(Zij·V)<<floor(QP/6).

Exemplary embodiments may also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium may also be distributed over network coupled computer systems so that the computer readable code is stored and executed in a distributed fashion.

According to exemplary embodiments, calculation complexity may be reduced and a calculation speed may be increased through an integer-based calculation process instead of a floating point calculation during transformation and inverse-transformation of a block having a larger size. Also, according to exemplary embodiments, a transformation error occurring in a transformation process using a discrete cosine transformation matrix in which a trigonometric function value is substituted by a rational number may be reduced.

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

1. A method of transforming an image, the method comprising:
obtaining a substituted discrete cosine transformation (DCT) matrix by substituting values based on a trigonometric function among elements of an N×N transformation matrix used for one-dimensional DCT of an N×N blockwith predetermined rational numbers, wherein the N is an integer;
obtaining an upscaling matrix for upscaling elements of the N×N block based on a maximum value of a denominator of an intermediate value generated in a calculation process of transforming the N×N block by using the substituted DCT matrix;
transforming the N×N block by using the upscaling matrix and the substituted DCT matrix; and
downscaling a transformed N×N block based on the maximum value of the denominator of the intermediate value generated in the calculation process of transforming the N×N block.

2. The method of claim 1, wherein, in the obtaining of the substituted DCT matrix, the values based on a trigonometric function are substituted with rational numbers whose denominator is 2̂p, and the p is a positive integer.

3. The method of claim 2, wherein, when generating the intermediate value in the transformation process using the substituted DCT matrix includes a multiplication process of the rational numbers whose denominator is 2̂p, a maximum number of the multiplication process of the rational numbers being K, and the K is an integer, the upscaling matrix is a matrix obtained by multiplying an N×N unit matrix and the value of 2̂(K*p).

4. The method of claim 1, wherein the transforming of the N×N block comprises:
upscaling the N×N block by using the upscaling matrix; and
transforming an upscaled N×N block by using the substituted DCT matrix.

5. The method of claim 1, further comprising:
factorizing the substituted DCT matrix into M-number of transformation matrixes, wherein the M is an integer; and
upscaling an input value input to each of the M-number of transformation matrixes and downscaling an output value of each of the M-number of transformation matrixes, with respect to each of the M-number of transformation matrixes.

6. The method of claim 1, wherein, when generating the intermediate value in the transformation process using the substituted DCT matrix includes a multiplication process of rational numbers whose denominator is 2̂p, a maximum number of the multiplication process of the rational numbers being K, and the K is an integer, the downscaling is performed by dividing the N×N transformation block by the value of 2̂(K*p).

7. The method of claim 1, further comprising:
obtaining a scaling matrix for compensating for a difference in a result value between when using the substituted DCT matrix and when using an original DCT matrix by using the substituted DCT matrix and a transposed matrix of the substituted DCT matrix; and
quantizing the transformed N×N block by using the scaling matrix and a quantization step.

8. A method of inverse-transforming an image, the method comprising:
obtaining a substituted inverse discrete cosine transformation (IDCT) matrix by substituting values based on a trigonometric function among elements of an N×N inverse-transformation matrix used for one-dimensional IDCT of an N×N block with predetermined rational numbers, wherein the N is an integer;
obtaining an upscaling matrix for upscaling elements of the N×N block based on a maximum value of a denominator of an intermediate value generated in a calculation process of inversely transforming the N×N block by using the substituted IDCT matrix;
inversely transforming the N×N block by using the upscaling matrix and the substituted IDCT matrix; and
downscaling an inversely transformed N×N block based on the maximum value of the denominator of the intermediate value generated in the calculation process of inversely transforming the N×N block.

9. The method of claim 8, where, in the obtaining of the substituted IDCT matrix, the values based on a trigonometric function are substituted with rational numbers whose denominator is 2̂p, and the p is a positive integer.

10. The method of claim 9, wherein, when generating the intermediate value in the inverse-transformation process using the substituted IDCT matrix includes a multiplication process of rational numbers whose denominator is 2̂p, a maximum number of the multiplication process of the rational numbers being K, and the K is an integer, the upscaling matrix is a matrix obtained by multiplying an N×N unit matrix and the value of 2̂(K*p).

11. The method of claim 8, wherein the inverse-transforming of the N×N block comprises:
upscaling the N×N block by using the upscaling matrix; and
inversely transforming an upscaled N×N block by using the substituted IDCT matrix.

12. The method of claim 8, further comprising:
factorizing the substituted IDCT matrix into M-number of inverse-transformation matrixes, wherein the M is an integer; and
upscaling an input value input to each of the M-number of inverse-transformation matrixes and downscaling an output value of each of the M-number of inverse-transformation matrixes, with respect to each of the M-number of inverse-transformation matrixes.

13. The method of claim 8, wherein, when generating the intermediate value in the inverse-transformation process using the substituted IDCT matrix includes a multiplication process of rational numbers whose denominator is 2̂p, a maximum number of the multiplication process of the rational numbers being K, and the K is an integer, the downscaling is performed by dividing the N×N transformation block by the value of 2̂(K*p).

14. The method of claim 8, further comprising:
obtaining a scaling matrix for compensating for a difference in a result value between when using the substituted IDCT matrix and when using an original IDCT matrix by using the substituted IDCT matrix and a transposed matrix of the substituted IDCT matrix; and
inversely quantizing the inversely transformed N×N block by using the scaling matrix and a quantization step.

15. The method of claim 14, wherein the inversely quantizing of the inversely transformed N×N block comprises:
obtaining an inverse quantization matrix to which a scaling operation is applied by an equation V=Qstep*PF*2̂n wherein V represents the inverse quantization matrix, Qstep represents a quantization step, PF represents a matrix obtained by multiplying elements of the scaling matrix by elements in the same position in a transposed matrix thereof, and the n is a positive integer; and
inversely quantizing a downscaled N×N block by using the inverse quantization matrix.

16. The method of claim 7, wherein the quantizing of the transformed N×N block comprises:
obtaining a quantization matrix to which a scaling operation is applied by an equation MF=PF*2̂m/Qstep wherein MF represents the quantization matrix, PF represents a matrix obtained by multiplying elements of the scaling matrix by elements in the same position in a transposed matrix thereof, the m is a positive integer, and Qstep represents a quantization step; and
quantizing a downscaled N×N block by using the quantization matrix.

17. The method of claim 1, wherein the transforming of the N×N block comprises multiplying the N×N block by an upscaled transformation matrix obtained by multiplying the upscaling matrix and the substituted DCT matrix.

18. The method of claim 8, wherein the inverse-transforming of the N×N block comprises multiplying the N×N block by an upscaled inverse-transformation matrix obtained by multiplying the upscaling matrix and the substituted IDCT matrix.

19. A non-transitory computer-readable recording medium having recorded thereon a program for executing the method of claim 1.

20. An image transformation apparatus comprising:
a transformer configured to obtain a substituted discrete cosine transformation (DCT) matrix by substituting values based on a trigonometric function among elements of an N×N transformation matrix used for one-dimensional DCT of an N×N block with predetermined rational numbers, wherein the N is an integer;
an upscaler configured to upscale the N×N block by using an upscaling matrix obtained based on a maximum value of a denominator of an intermediate value generated in a calculation process of transforming the N×N block by using the substituted DCT matrix; and
a downscaler configured to downscale a transformed N×N block by using the maximum value of the denominator of the intermediate value generated in the calculation process of transforming the N×N block, wherein the transformation unit transforms the N×N block by using the upscaling matrix and the substituted DCT matrix.
